(19) United States
(12) Patent Application Publication
(10) Pub. No.: US 2012/0290145 A1
(43) Pub. Date: Nov. 15, 2012

(54) Single-stage grid-connected solar inverter for distributed reactive power generation

(76) Inventors: Madhuwanti Joshi, Edison, NJ (US); Hussam Alatrash, South Plainfield, NJ (US); Bruce Modick, Boonton, NJ (US); Ronald Decker, Tumersville, NJ (US); Johan Enslin, Apex, NC (US)

(21) Appl. No.: 13/068,390

(22) Filed: May 10, 2011

(51) Int. Cl. G06F 1/28; H02J 3/38; H02M 7/72

(52) U.S. Cl. 700/298; 363/124; 307/85

(57) ABSTRACT

The present invention proposes a method and a system for generating a bidirectional power flow between a DC component and an AC grid for a distributed power generation system using solar panels. The system includes an inverter that further includes a DC component for generating DC power and a single-stage DC-AC converter for converting the DC power into AC power by operating in one or more pre-defined modes. The AC power includes a reactive power component and an active power component.

### FIELD OF THE INVENTION

The present invention relates, in general, to the field of distributed power generation systems and, in particular, to a method and a system for efficient power flow in electric grid systems by using a single-stage flyback converter.

### BACKGROUND

Over the past few years, technological innovations, changing economic and regulatory environments, and shifting environmental and social priorities have spurred interest in Distributed Generation (DG) systems. Distributed generation is a new model for the power system that is based on the integration of small-sized and medium-sized generators which use new and renewable energy technologies, such as solar, wind, and fuel cells, to a utility grid. The DG systems use one or more micro grids for generating power. A micro grid is a localized power generation system that operates in connection with the utility grid, which is also referred to as the main grid or the macro grid. For specific operations, the micro grid may be disconnected from the main grid to function autonomously in an isolated mode. One of the examples of micro grids is Solar Inverters, widely used for generating electrical energy in DG systems by using solar energy.

Solar inverters employ solar panels as a source of DC voltage for generating an AC grid voltage. In existing systems, a DC voltage is generated by a DC component, such as a solar panel, and undergoes DC-AC conversion to produce AC power that is transmitted to the utility grid. The DC-AC conversion is attained in two stages, such that the first stage converts the low DC voltage generated by the DC component into an amplified DC voltage. This conversion is attained with the help of a DC-DC converter. Thereafter, the amplified DC voltage is converted into an AC voltage by a DC-AC converter. In existing systems, the DC-AC converter may include a high-frequency inverter. The high-frequency inverter employed in the existing systems may include a Pulse Width Modulation (PWM) inverter. In recent times, the two-stage DC-AC converters have been replaced by single-stage inverters to avoid the high-frequency stages that considerably limit the operation of the two-stage DC-AC converter.

With the growing demand from utilities, the distributed generation system using existing single-stage inverters has limitations. For example, a number of times it is necessary to generate active and reactive power using solar panels. This helps the utility grid to implement a power factor correction local to the loads drawing reactive power from the grid. Implementing a power factor correction local to the loads refers to implementing the correction very close to the load. Some existing systems use a two-stage approach to reactive power as previously mentioned. With the two-stage approach, the losses due to the high-frequency stages of the solar inverter are significant. Therefore, the user has to either compromise on efficiency or on reactive power. The present invention helps in achieving the active and reactive power generation while maintaining high efficiency.

In light of the foregoing discussion, there is a need for an improved topology of an inverter used for converting the DC power of a DC component into an AC power, while achieving high reliability, high efficiency, and low cost. Also, the improved topology should be able to provide reactive power as needed by reactive loads while maintaining the overall system power factor.

### SUMMARY

An objective of the present invention is to provide a method and a system for generating a bidirectional power flow between a DC component and an AC grid.

Another objective of the invention is to provide an improved topology for a single stage DC-AC converter which has a high efficiency.

Another objective of the invention is to provide an improved topology for use in inverters, wherein the improved topology generates reactive power to support reactive loads.

Another objective of the invention is to provide a control circuit and logic to sense the grid current and generate desired current magnitude and phase difference.

Yet another objective of the invention is to provide an improved topology for use in inverters, wherein the improved topology provides a single-stage conversion of DC power generated by the DC component into AC power.

An additional objective of the present invention is to provide a single-stage conversion of the DC power into AC power by using a single-stage flyback converter.

Embodiments of the present invention provide an inverter that includes a DC component for generating DC power. Further, the inverter includes a single-stage converter for generating a bidirectional power flow between the DC component and an AC grid. The bidirectional power flow is generated by converting the DC power into AC power by operating in one or more pre-defined modes such that the generated AC power is received by the AC grid/load. In various embodiments of the invention, the load may be an electrical equipment, a group of electrical equipments or the AC grid itself. Further, in accordance with the present invention, the generated AC power comprises a reactive power component and an active power component.

Embodiments of the invention further provide a solar inverter that includes a solar panel for generating DC power and a single-stage converter for generating a bidirectional power flow between the solar panel and an AC grid. The bidirectional power flow is generated by converting the DC power into AC power by operating in one or more pre-defined modes such that the generated bidirectional AC power is received by the AC grid. Further, the generated AC power comprises a reactive power component and an active power component.

Embodiments of the present invention further provide a DC to AC (DC-AC) converter for generating a bidirectional power flow between a DC component and an AC grid such that the DC-AC converter includes a single-stage flyback converter for converting a DC power of the DC component into an AC power by operating in one or more pre-defined modes, and the AC power is received by the AC grid. Further, the generated AC power comprises a reactive component and an active component.

Embodiments of the present invention further provide a method for generating a bidirectional power flow between a DC component and an AC grid, such that the method includes generating a DC power by a DC component and converting the generated DC power into AC power in a single stage. The conversion is performed in one or more pre-defined modes. Further, in accordance with the present invention, the generated AC power comprises a reactive power component and an active power component.

### BRIEF DESCRIPTION OF THE DRAWINGS

Various embodiments of the present invention will, hereinafter, be described in conjunction with the appended drawings that are provided to illustrate, and not to limit, the present invention, wherein like designations denote like elements, and in which;

FIG. 1 depicts an exemplary inverter, in which various embodiments of the present invention can be practiced;

FIG. 2 is a block diagram illustrating one or more modules of a control circuitry of a DC to AC converter of the inverter, in accordance with an embodiment of the present invention;

FIG. 3 shows the AC voltage and AC current waveforms corresponding to the AC power generated by the inverter, in accordance with the embodiment of the present invention;

FIG. 4a shows operation of the exemplary inverter in a first mode, in accordance with the embodiment of the present invention;

FIG. 4b shows operation of the exemplary inverter in a second mode, in accordance with the embodiment of the present invention;

FIG. 4c shows operation of the exemplary inverter in a third mode, in accordance with the embodiment of the present invention;

FIG. 4d shows operation of the exemplary inverter in a fourth mode, in accordance with an embodiment of the present invention;

FIG. 5 is a flow chart illustrating a method for generating a bidirectional power flow between the DC component and the AC grid, in accordance with an embodiment of the present invention; and

FIG. 6 is a flow chart illustrating a method for controlling the operation of the inverter in one or more pre-defined modes, in accordance with an embodiment of the present invention.

Skilled artisans will appreciate that the elements in the figures are illustrated for simplicity and clarity to help improve the understanding of the embodiments of the present invention and are not intended to limit the scope of the present invention in any manner whatsoever.

### DETAILED DESCRIPTION OF THE INVENTION

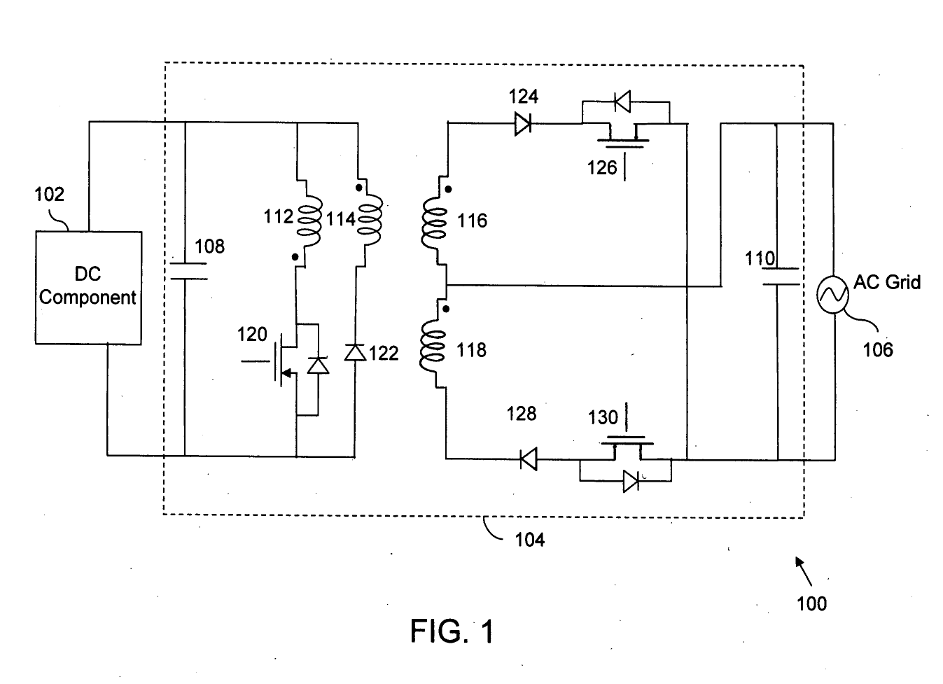

FIG. 1 depicts an exemplary inverter 100 in which various embodiments of the invention can be practiced. The inverter 100 includes a DC component 102, a DC to AC (DC-AC) converter 104, and an AC grid 106. In accordance with another embodiment of the invention, the inverter may have multiple DC to AC converters connected in series or parallel or a combination of both to the same DC component 102 at the input and AC grid 106 at the output. In accordance with an embodiment of the invention, the DC component 102 is a solar panel. In the embodiments where the DC component 102 is a solar panel, the inverter 100 may be referred to as a solar inverter. In accordance with an embodiment of the invention, the DC-AC converter 104 is a single-stage flyback converter. Further referring to FIG. 1, the DC-AC converter 104 includes a capacitor 108 and a capacitor 110, wherein the capacitor 108 is connected across the DC component 102 and the capacitor 110 is connected across the AC grid 106. It will be apparent to a person skilled in the art that, in different embodiments of the present invention, the capacitor 108 and the capacitor 110 may be replaced by one or more capacitors connected in series or in parallel. The DC-AC converter 104 further comprises a plurality of inductors 112, 114, 116, and 118 such that the inductors 112 and 114 are connected to the DC side of the DC-AC converter 104 and inductors 116 and 118 are connected to the AC side of the DC-AC converter 104. The inductors 112, 114, 116, and 118 are magnetically coupled to each other, that is, they share a common magnetic field with each other. Further, it will be apparent to a person skilled in art that, in different embodiments of the present invention, the inductors 112, 114, 116, and 118 can be replaced by one or more inductors connected in series or in parallel. The inductor 112 is connected in series with a switch 120 such that the inductor 112 is energized when the switch 120 is ON. The inductor 114 is connected in series with a diode 122 such that the inductor stores and feeds energy back to the DC component 102 when the diode 122 is in the ON state. The series combination of the inductor 112 and the switch 120 and the series combination of the inductor 114 and the diode 122 are connected in parallel with each other.

Although the description above has been written considering that the DC component 102 is a solar panel, it will be apparent to a person skilled in art that the DC component 102 may be generated from other energy sources such as a fuel cell.

On the AC side of the DC-AC converter 104, a series combination of a diode 124 and a switch 126 is connected in the circuit for storing energy in the inductor 116 and transferring the energy to the AC side when the inverter 100 is operated in a Mode 2. The series connection of the diode 124 and the switch 126 is further used for energizing the inductor 116 when the inverter 100 is operated in a Mode 3. Further, a series combination of a diode 128 and a switch 130 is connected in the circuit for storing energy in the inductor 118 when the inverter 100 is operated in a Mode 1, and for energizing the inductor when the inverter 100 is operated in a Mode 4. Mode 1, Mode 2, Mode 3, and Mode 4 of operation of the inverter 100 will be described in detail later. For a person skilled in art, it will be understood that the switches 120, 126, and 130 can be P channel or N channel Metal oxide Semiconductor Field Effect Transistors (MOSFETs), PT type or NPT Insulated Gate Bipolar Transistors (IGBTs), NPN and PNP type of Bipolar Junction Transistors (BJTs), and the like. Further, in another embodiment of the invention, the plurality of inductors 112, 114, 116 and 118 may also be part of a transformer. In accordance with another embodiment of the invention, the plurality of inductors 112, 114, 116, and 118 are magnetically coupled inductors. The inverter 100 is operated in one or more pre-defined modes by switching the switches 120, 126, and, 130 and the diodes 122, 124, and 128 in one of ‘ON’ and ‘OFF’ states. In accordance with an embodiment of the invention, the operation of DC-AC converter 104 is controlled by a control circuitry as explained in detail later. In different embodiments of the present invention, the inductors 112, 114, 116, and 118 can be formed by using a combination of one or more inductors. Also, in different embodiments of the present invention, the switches 120, 126, and 130 can be formed using one or more switches connected in series or parallel. Similarly, the diodes 124, 128, and 122 can also be formed by using one or more diodes on series or parallel.

Therefore, by operating the inverter 100 in one or more pre-defined modes and by transitioning from one pre-defined mode to another pre-defined mode, bidirectional power, i.e., positive power and negative power, is generated between the DC component 102 and the AC grid 106. The positive power flow refers to the power flow from the DC component 102 to the AC grid 106. The negative power flow refers to the power flow from the AC grid 106 to the DC component 102. Further, the bidirectional power flow results from the generation of reactive power by the inverter 100.

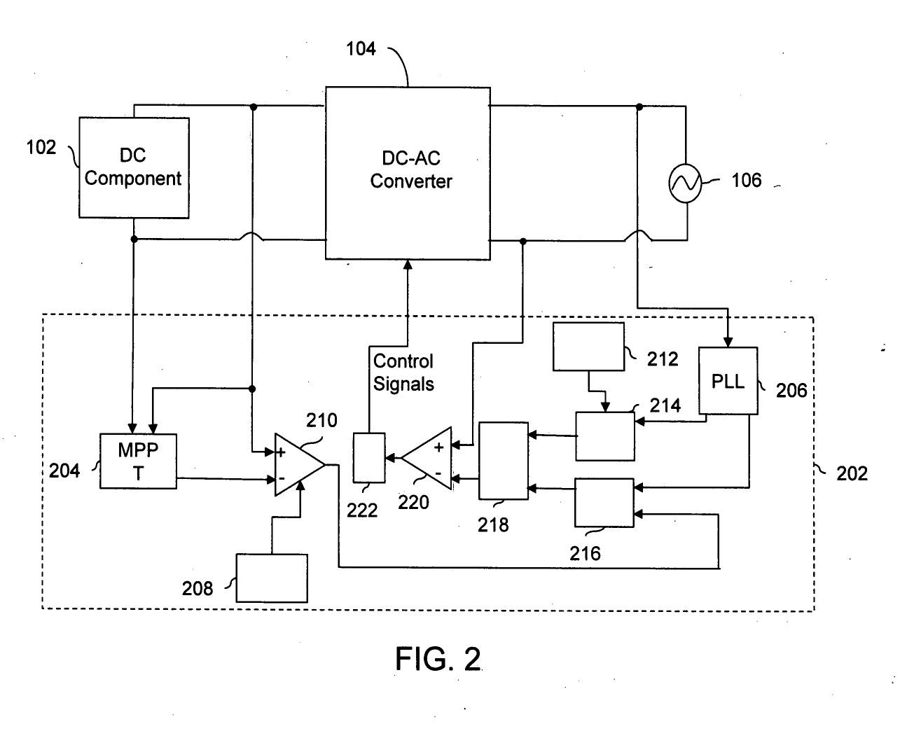

FIG. 2 is a block diagram illustrating one or more modules of the control circuitry 202 of the DC-AC converter 104, in accordance with an embodiment of the present invention. As mentioned above, the operation of the inverter 100 in one or more pre-defined modes is controlled by the control circuitry 202. To further elaborate, the control circuitry 202 includes a Maximum Power Point Tracking (MPPT) calculation module 204, a Phase Locked Loop (PLL) generator 206, a current limit block 208, a voltage regulator 210, a reactive power controller (VAR controller) 212, a plurality of multipliers 214 and 216, an adder 218, a current regulator 220, and a modulator 222. In an embodiment of the invention, control circuitry 202 may also be referred to as a controller.

The control circuitry 202 controls the operation of the inverter 100 by providing voltage and current regulation which drives the DC-AC converter 104 to operate it in the one or more pre-defined modes. A control operation senses the current Iₛₑₙₛ at the output of the DC-AC converter 104. Thereafter, the current Iₛₑₙₛ is provided to the current regulator 220 that compares the sensed current Iₛₑₙₛ and a reference current I_{ref}. For a person skilled in the art, it will be understood that the reference current I_{ref} comprises a current magnitude and a current wave shape. Further, it will be apparent to a person skilled in the art that the reference current I_{ref} is the current that is required to flow into the AC grid 106.

The current magnitude of the reference current I_{ref} is calculated by the MPPT calculation module 204. The MPPT calculation module 204 calculates the magnitude of the current for the reference current I_{ref} using the input voltage and the current received from the DC component 102, such as a solar panel, to its maximum power point (or value). The current value and voltage value from the DC component 102 are sensed to determine the maximum power obtainable from the DC component 102. The magnitude of I_{ref} is derived from this power. The current magnitude Iᵣₘₛ and the waveform generated by the PLL generator as described below are used to generate the reference current I_{ref}.

The current wave shape of the reference current I_{ref} is generated from the PLL generator 206. The PLL generator 206 receives an input signal from the AC grid voltage of the AC grid 106. The PLL generator 206 generates a sine wave shape and a cosine wave shape such that the sine wave shape and the cosine wave shape are in 90 degree phase difference with each other. The sine wave shape and the cosine wave shape generated by the PLL generator 206 are used to generate the desired phase of the output AC current with respect to the AC voltage. In various embodiments of the invention, the phase difference can be from 0 to 90 degree leading or 0 to 90 degree lagging.

The current magnitude generated by the MPPT calculation module 204 and the current wave shapes (sine and cosine) generated by the PLL generator 206 are multiplied by the multipliers 214 and 216 and then combined by the adder 218 for generating the reference current I_{ref}, in accordance with a predetermined value of reactive power stored in the VAR controller 212. In accordance with an embodiment of the invention, the VAR controller 212 is pre-programmed to determine the reactive power to be generated by the DC-AC converter 104.

In accordance with embodiments of the present invention, the control circuitry 202 is operated in one or more operation modes. The one or more operation modes include a continuous conduction mode, a discontinuous conduction mode, and a boundary mode, where the operation takes place between the continuous conduction mode and the discontinuous conduction mode. For a person skilled in the art, it will be understood that while operating in the continuous conduction mode, the current in the DC-AC converter 104 fluctuates, but is always a non-zero value. For a person skilled in the art, it will be further understood that while operating in the discontinuous mode, the current in the DC-AC converter 104 fluctuates and reaches a value of zero before the end of each pre-defined mode. Further, the operation of the control circuitry 202 is discussed in detail with the help of two operating loops, where each of the two operating loops is a subsection of the control circuitry 202. In accordance with the embodiments of the present invention, the two operating loops include an output current regulation loop and an input voltage regulation loop.

The output current regulation loop senses the grid current of the AC grid 106 and controls the generation of instantaneous output current of the inverter 100 in accordance with the sensed current. The generation of instantaneous output current is controlled such that the output AC current (or the grid current) follows the reference current I_{ref}.

The input voltage regulation loop senses the input voltage of the DC component 102 and controls the generation of the magnitude of the reference current I_{ref} with which the sensed current Iₛₑₙₛ is compared. The input voltage regulation loop matches the input voltage to a reference point provided by the MPPT calculation module 204. This is based on the determination of an approximate value of the maximum power point at which the DC component may be operated. In accordance with an embodiment of the invention, the maximum power point corresponds to the value of DC current and DC voltage at which the DC component 102 is operated to generate a maximum power at the input of the DC-AC converter 104. The reference current l_{ref} further modulates the amplitude of the output current of the DC-AC converter 104 to vary the average power injected into the AC grid 106. In accordance with the maximum power point value provided by the MPPT calculation module 204 and a predetermined value stored in the current limit block 208, the current magnitude is provided to the multipliers 214 and 216 for being multiplied with the wave shapes generated by PLL generator 206. This facilitates the generation of the reference current I_{ref} as defined above. At certain conditions such as very high/very low temperatures, it is desirable to limit the AC power generated by the DC component 102. This is done by the current limit block 208, which limits the maximum current which can be drawn from the DC component 102.

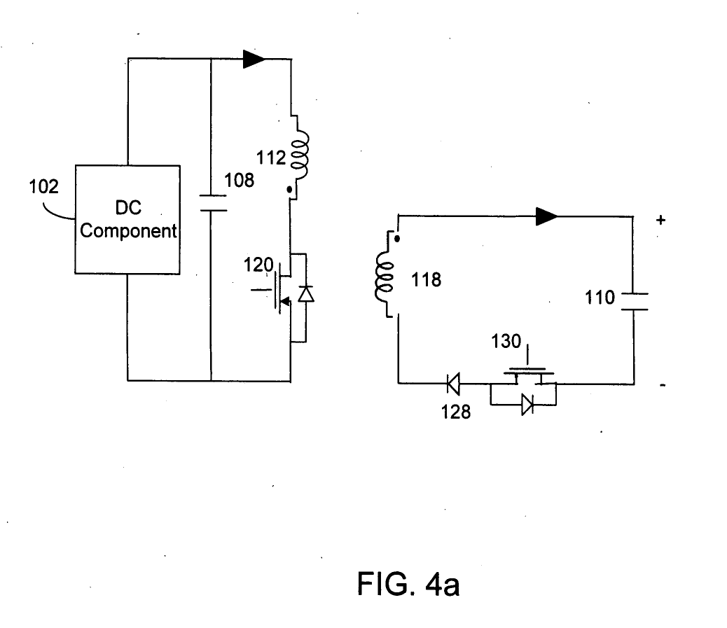

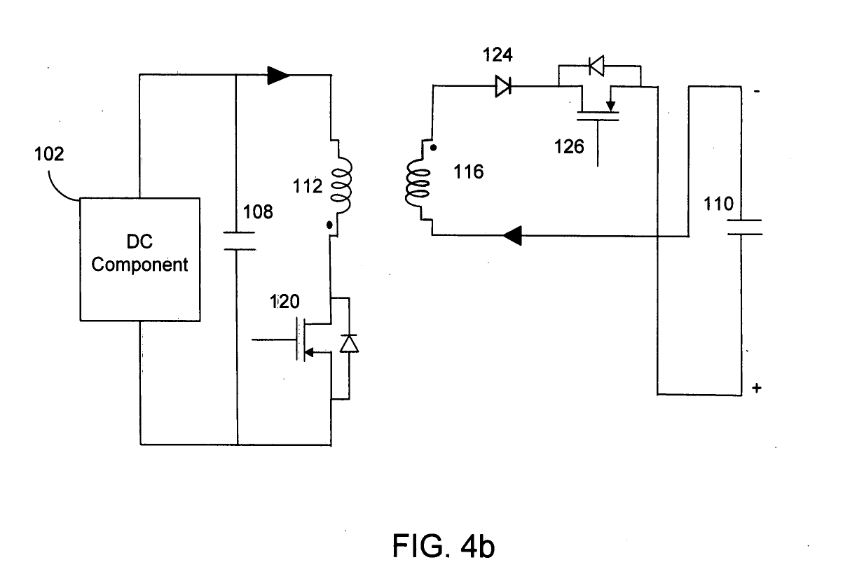

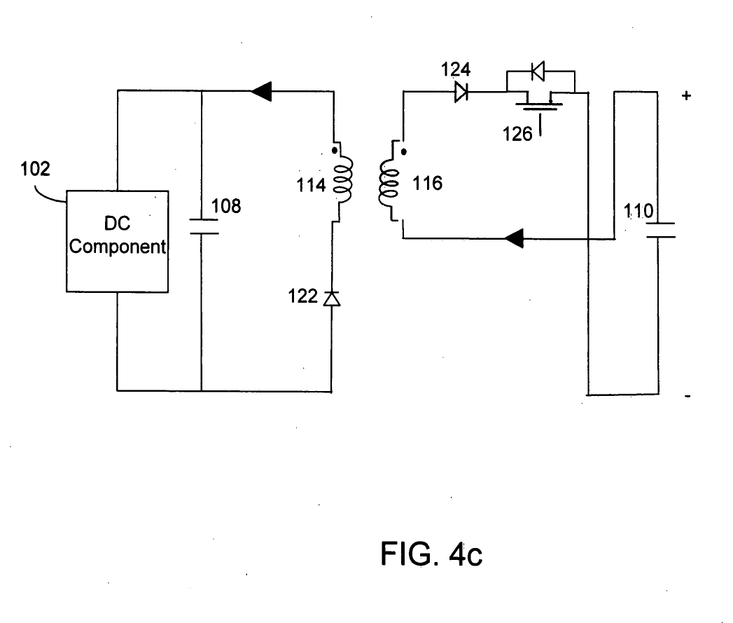

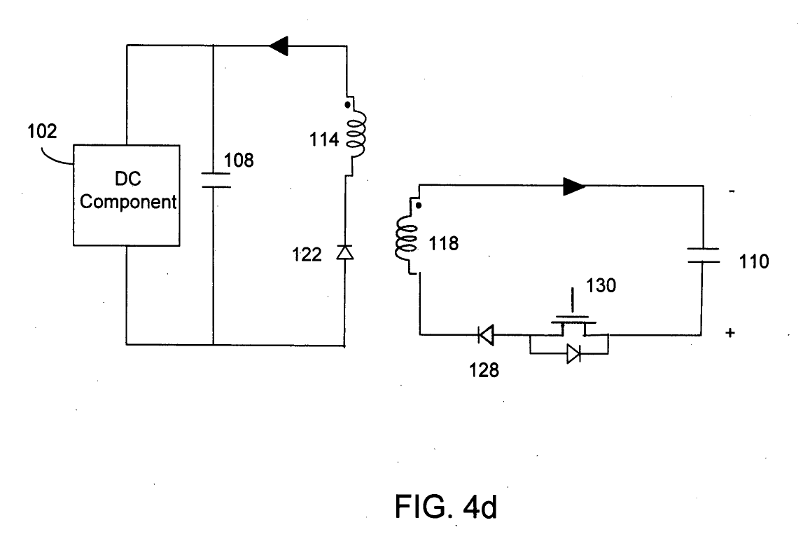

The reference current I_{ref} and the sensed current Iₛₑₙₛ are compared at the current regulator 220 to drive the modulator 222 for generating control signals. The control signals hence generated by the modulator 222 control the operation of the DC-AC converter 104 in the one or more pre-defined modes by switching one or more of the plurality of switches 120, 126, and 130 illustrated in FIG. 1. Moreover, the one or more pre-defined modes are described below in greater detail in conjunction with FIGS. 4a, 4b, 4c, and 4d.

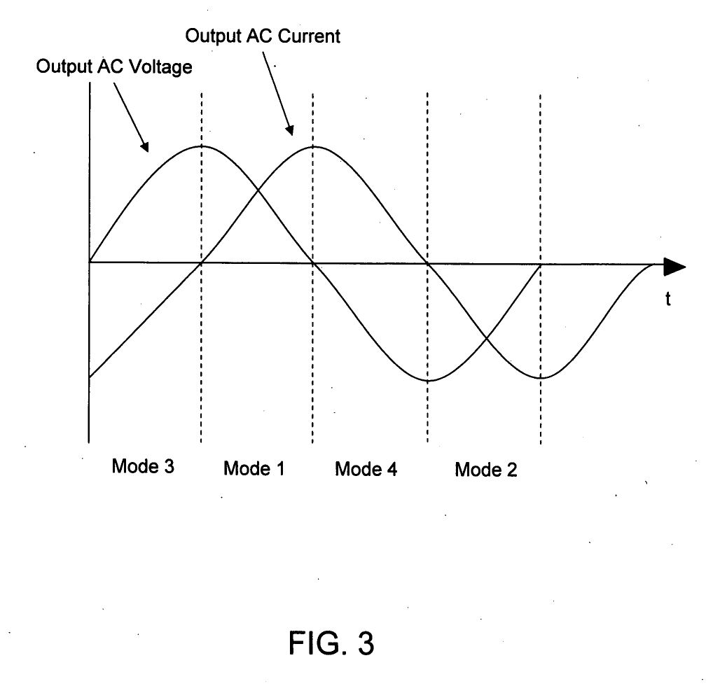

FIG. 3 shows variation in the output AC voltage and the output AC current of the inverter 100 with respect to time, in accordance with an embodiment of the present invention. As illustrated in FIG. 3, the output AC voltage and the output AC current have a phase difference of 90 degrees. In other embodiments of the invention, the phase difference can be from 0 to 90 degrees leading or 0 to 90 degrees lagging. The DC-AC converter 104 of the inverter 100 is operated in the one or more pre-defined modes to generate the output AC voltage and the output AC current as illustrated in FIG. 3, where the operation of the inverter 100 in the one or more pre-defined modes is controlled by the control circuitry 202. Operation in one or more modes further includes transitioning from one mode of the one or more pre-defined modes to another mode. In the waveforms illustrated in FIG. 3, the output AC voltage and the output AC current are generated by transitioning from one pre-defined mode to another in the following sequence: Mode 3, Mode 1, Mode 4, and Mode 2. The operation of the inverter 100 in one or more modes is explained in greater detail in the subsequent paragraphs.

As illustrated in FIG. 3, the operation of the inverter 100 begins in Mode 3, such that the output AC voltage is positive and the output AC current is negative. This leads to a negative power flow, i.e., the power flows from the AC grid 106 to the DC component 102. Following the operation in Mode 3, the inverter 100 is operated in Mode 1, where both the output AC voltage and the output AC current of the inverter 100 are positive. This results in a positive power flow across the DC-AC converter, such that the power flows from the DC component 102 to the AC grid 106. Subsequent to the operation in Mode 1, there is transition to Mode 4, as illustrated in FIG. 3. While operating in this mode, a negative output AC voltage and a positive output AC current is generated. This again leads to a negative power flow across the DC-AC converter 104, such that the power flows from the AC grid 106 to the DC component 102. Finally, the operation of the inverter 100 is transited to occur in Mode 2, where both the output AC voltage and the output AC current have a negative value, as illustrated in FIG. 3. This results in a positive power flow across the DC-AC converter 104, such that the power flows from the DC component 102 to the AC grid 106.

Therefore, by operating the inverter 100 in one or more pre-defined modes and by transitioning from one defined mode to another pre-defined mode, a bidirectional power, i.e., positive power and negative power flow between the DC component 102 and the AC grid 106, is generated. The positive power flow refers to the power flow from the inverter 100 to the AC grid 106. The negative power flow refers to the power flow from the AC grid 106 to the inverter 100. For a person skilled in art, it is understood that the present invention may be practiced in various other modes apart from the pre-defined modes explained above. The operation in each of the above modes includes the switching ‘ON’ and switching ‘OFF’ of one or more of the plurality of switches 120, 126, and 130 and the diodes 122, 124, and 128 of the DC-AC converter 104 of the inverter 100 by the control circuitry 202. The operation of the inverter 100 in each of the above modes is discussed in detail in conjunction with FIG. 4a, FIG. 4b, FIG. 4c, and FIG. 4d in the subsequent paragraphs.

FIG. 4a illustrates the operation of the inverter 100 in a first pre-defined mode in accordance with an embodiment of the invention. This mode is illustrated as Mode 1 in FIG. 3. The control circuitry 202 generates control signals such that the switch 120 of the DC-AC converter 104 is closed and a DC current flows through the inductor 112 and the switch 120. When the switch 120 is opened, the dotted terminal of inductor 118 becomes positive. The switch 130 is closed at this time, and the current flows through the diode 128, the switch 130, and the capacitor 110. The power flows from the DC component 102 to the AC grid 106 in this mode. Thus, the energy associated with inductor 118 is transferred to the AC grid 106 and a positive AC voltage and a positive AC current is obtained at the output of the DC-AC converter 104, resulting in a positive power flow between the DC component 102 and the AC grid 106. In an embodiment of the invention, the DC-AC converter 104 is a single-stage flyback converter. For a person skilled in the art, it will be understood that the operation of the flyback converter in the first mode is similar to the standard operation of the flyback converter.

FIG. 4b illustrates the operation of the inverter 100 in a second pre-defined mode, in accordance with the embodiment of the invention. This mode is illustrated as Mode 2 in the FIG. 3. The control circuitry 202 generates control signals such that the switch 120 of the DC-AC converter 104 is closed and the DC current flows through the inductor 112 and the switch 120. When the switch 120 is opened, the dotted terminal of inductor 116 becomes positive. The switch 126 is closed at this time. The current in the inductor 112 gets reflected to the inductor 116 and it flows though the diode 124, the switch 126, and the capacitor 110. The direction of the output current is the same as the polarity of output voltage. Therefore, the power is positive and it flows from the DC component 102 to the AC grid 106.

FIG. 4c illustrates the operation of the inverter 100 in a third pre-defined mode, in accordance with the embodiment of the invention. This mode starts when the AC grid voltage of the AC grid 106 is positive and the AC grid current of the AC grid 106 is negative. The inductor 116 stores the energy by closing the switch 126. When the switch 126 is opened, the current in the inductor 116 is transferred to the inductor 114. The dotted terminal of inductor 114 becomes positive and the current flows through diode 122 and capacitor 108. Thus, the energy is stored at the input side from the AC grid 106. This mode is illustrated as Mode 3 in the FIG. 3.

FIG. 4d illustrates the operation of the inverter 100 in a fourth pre-defined mode, in accordance with the embodiment of the invention. The inductor 118 stores the energy by closing the switch 130. When the switch 130 is opened, current flowing in the inductor 118 gets transferred to the inductor/winding 114, and it flows into the capacitor 108 via diode 122. The switch 126 remains open during this time. This mode is illustrated as Mode 4 in the FIG. 3.

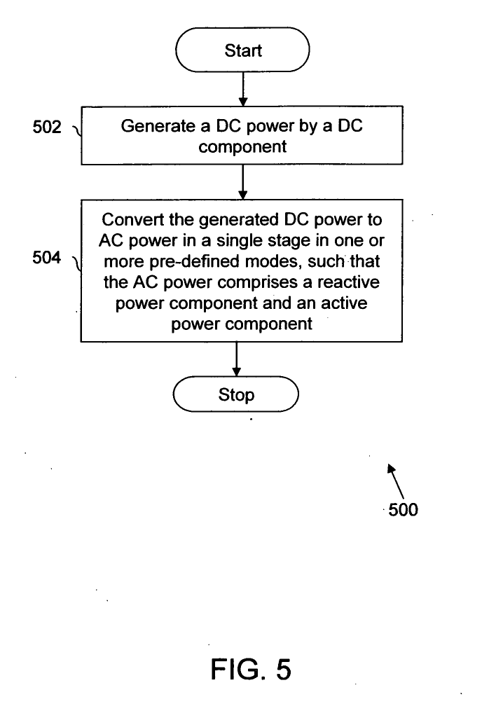

FIG. 5 is a flowchart illustrating a method for generating a bidirectional power flow between a DC component such as the DC component 102 and an AC grid such as the AC grid 106, in accordance with an embodiment of the present invention. The bidirectional power flow is generated by a DC-AC converter, such as the DC-AC converter 104, which is controlled to operate in one or more pre-defined modes.

Initially, at step 502, the DC power is generated by the DC component. In accordance with an embodiment of the invention, the DC power is generated by a solar panel which acts as the DC component. The DC power thereby generated includes a DC current component and a DC voltage component.

At step 504, the generated DC power is converted into an AC power by the DC-AC converter, where the AC power includes a reactive power component and an active power component. The power flow from the DC component to the AC grid refers to the active power component. In this case, the direction of output current and the polarity of output voltage is in the same direction. The power flow from the AC grid to the DC component refers to the reactive power. In this case, the direction of output current and the polarity of output voltage are in opposite direction. In an embodiment of an invention, the DC-AC converter is a single-stage DC-AC converter. Further, the DC power is converted into AC power by operating the DC-AC converter in one or more pre-defined modes, such that the operation is controlled by a control circuitry such as the control circuitry 202. Further, the operation of the DC-AC converter in one or more pre-defined modes by utilizing the control signals generated by the control circuitry has already been explained in detail in conjunction with FIGS. 4a, 4b, 4c, and 4d.

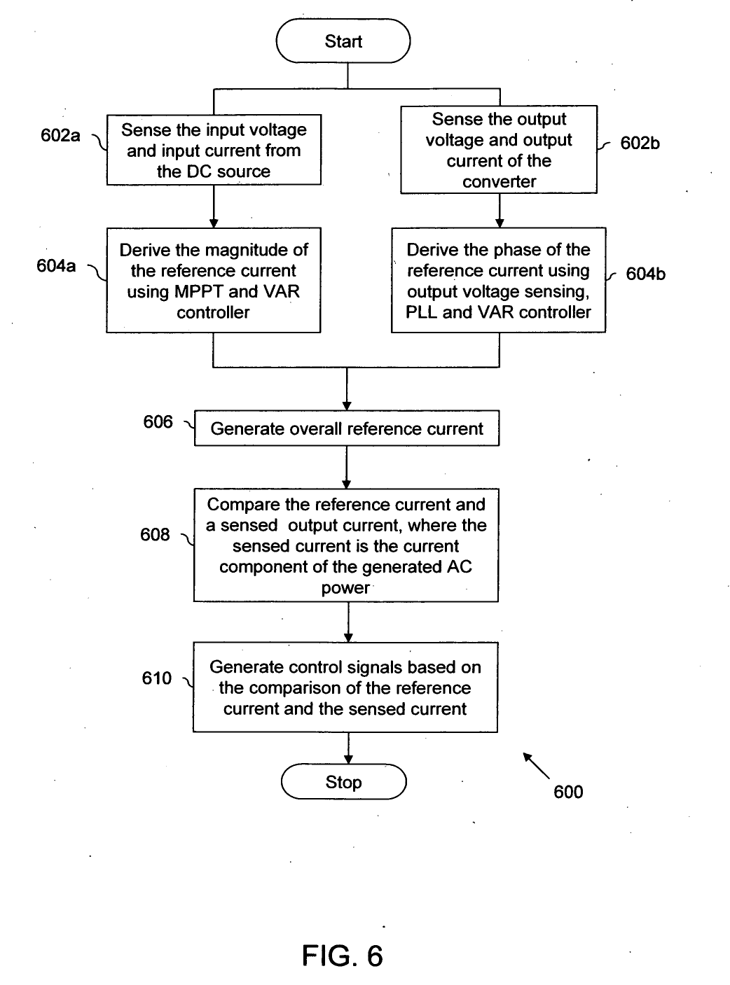

FIG. 6 is a flowchart illustrating a method for controlling the operation of an inverter such as the inverter 100 in one or more pre-defined modes, in accordance with an embodiment of the present invention. The bidirectional power flow is generated by the DC-AC converter which is controlled by the control circuitry to operate in one or more pre-defined modes as already explained in the previous paragraphs.

To start with, at step 602a, an input voltage and an input current from the DC component is sensed. In the next step 604a, a magnitude of a reference current is derived based on the values sensed in step 602a. This is done by using an MPPT calculation module, such as the MPPT calculation module 204, and a VAR controller, such as the VAR controller 212. Steps 602b and 604b are preferably performed at the same time as steps 602a and 604a. At step 602b, an output voltage and an output current of the DC-AC converter are sensed. Further, at step 604b, the phase of the reference current is derived based on the output voltage of the DC-AC converter sensed in step 602b. The phase of the reference current is generated by using a PLL generator, such as the PLL generator 206, and the VAR controller. At step 606, the reference current I_{ref} is generated based on the magnitude and the phase of the reference current generated in the previous steps. At step 608, the reference current I_{ref} generated in the previous step is compared to the sensed current Iₛₑₙₛ from step 602b. As already explained in the above paragraphs, the sensed current Iₛₑₙₛ is the current component of the generated AC power obtained at the output of the inverter. Thereafter, at step 610, control signals are generated based on the comparison of the reference current I_{ref} and the sensed current Iₛₑₙₛ to drive the DC-AC converter to operate in the one or more pre-defined modes. The operation of the DC-AC converter in one or more pre-defined modes by utilizing the control signals generated by the control circuitry has already been explained in detail in conjunction with FIGS. 4a, 4b, 4c, and 4d.

The present invention described above has numerous advantages. In particular, the present invention provides an improved topology for generating a bidirectional power flow between the DC component and the AC grid. Further, the improved topology is capable of generating an AC power that includes both the active power component and the reactive power component. Further, the improved topology utilizes a single-stage flyback converter which facilitates high efficiency and reliability and reduces cost. Also, it eliminates the need to have two separate high-switching frequency stages. Since the topology requires less number of components, the solar inverters of the present invention consume less space. The present invention further focuses on using only one switching stage, which helps in further reducing the switching or frequency losses to a great extent. The topology focuses on controlling the single-stage flyback converter over a wide range of operating conditions in an efficient manner.

While various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. An inverter comprising:
a DC component for generating DC power; and
a single stage converter configured for converting the DC power to AC power by operating in one or more pre-defined modes and for generating a bidirectional power flow between the DC component and an AC grid, wherein the AC power comprises a reactive power component and an active power component.

2. The inverter of claim 1, wherein the DC component is a solar panel.

3. The inverter of claim 1, wherein the single stage converter is a single stage flyback converter.

4. The inverter of claim 1, wherein the single stage converter comprises at least one coupled inductor/transformer connected with one or more switches.

5. The inverter of claim 1, wherein the generated AC power according to a first pre-defined mode comprises a positive voltage component and a positive current component.

6. The inverter of claim 1, wherein the generated AC power according to a second pre-defined mode comprises a negative voltage component and a positive current component.

7. The inverter of claim 1, wherein the generated AC power according to a third pre-defined mode comprises a positive voltage component and a negative current component.

8. The inverter of claim 1, wherein the generated AC power according to a fourth pre-defined mode comprises a negative voltage component and a negative current component.

9. The inverter of claim 1 further comprising a control circuitry for controlling the operation of the single stage converter in one or more pre-defined modes.

10. The inverter of claim 9, wherein controlling the operation in one or more pre-defined modes by the control circuitry comprises transitioning from one of the one or more pre-defined modes to another one of the remaining one or more pre-defined modes.

11. The inverter of claim 9, wherein the control circuitry comprises:
a Maximum Power Point Tracking (MPPT) calculation module for calculating a voltage value of the DC component and a current value of the DC component corresponding to a maximum power point wherein the voltage value and the current value are calculated for determining magnitude of a reference current;
a Phase Locked Loop (PLL) generator for generating a wave shape of the reference current, the wave shape being generated by sensing a grid voltage of the AC grid;
a current regulator for comparing the reference current and a sensed current, wherein the sensed current is collected from an output of the inverter; and
a modulator for generating a plurality of control signals for controlling the operation of the single stage converter in one or more pre-defined modes based on the comparison of the reference current and the sensed current.

12. A solar inverter comprising:
a solar panel for generating DC power; and
a single stage converter for generating a bidirectional power flow between the solar panel and an AC grid, the bidirectional power flow being generated by converting the DC power to AC power by operating in one or more pre-defined modes, wherein the AC power comprises a reactive power component and an active power component.

13. A DC to AC converter for generating a bidirectional power flow between a DC component and an AC grid, the DC to AC converter comprising:
a single stage flyback converter configured for converting a DC power of the DC component to an AC power by operating in one or more pre-defined modes, wherein the AC power is received by the AC grid, and wherein the AC power comprises a reactive component and an active component.

14. A method for generating a bidirectional power flow between a DC component and an AC grid, the method comprising:
generating a DC power by a DC component; and
converting the generated DC power to AC power in a single stage, the conversion being performed in one or more pre-defined modes, wherein the AC power comprises a reactive power component and an active power component.

15. The method of claim 14, wherein the generated AC power according to a first pre-defined mode comprises a positive voltage component and a positive current component.

16. The method of claim 14, wherein the generated AC power according to a second pre-defined mode comprises a negative voltage component and a positive current component.

17. The method of claim 14, wherein the generated AC power according to a third pre-defined mode comprises a positive voltage component and a negative current component.

18. The method of claim 14, wherein the generated AC power according to a fourth pre-defined mode comprises a negative voltage component and a negative current component.

19. The method of claim 14, wherein generating the bidirectional power flow between the DC component and the AC grid further comprises controlling the operation of a single stage DC-AC converter in one or more pre-defined modes.

20. The method of claim 19, wherein controlling the operation in one or more pre-defined modes comprises transitioning from one of the one or more pre-defined modes to another one of the remaining one or more pre-defined modes.

21. The method of claim 20, wherein controlling the operation in one or more pre-defined modes comprises:
generating a reference current based on a voltage value of the DC component and a current value of the DC component and a voltage component of the generated AC power;
comparing the reference current and a sensed current, wherein the sensed current is a current component of the generated AC power; and
generating a plurality of control signals based on the comparison of the reference current and the sensed current.
